(19) United States
(12) Patent Application Publication
(10) Pub. No.: US 2026/0111294 A1
(43) Pub. Date: Apr. 23, 2026

(54) MODULAR ARCHITECTURE

(71) Applicant: NICOVENTURES TRADING LIMITED, London (GB)

(72) Inventors: Najeeb YOUNOSSI, London (GB); Roberto PELLEGRINI, Milano (IT); Paolo PARIANI, Milano (IT); Massimiliano GALANTI, Milano (IT)

(21) Appl. No.: 19/134,511

(22) PCT Filed: Dec. 1, 2023
(86) PCT No.: PCT/EP2023/084002

§ 371 Date: May 30, 2025

(30) Foreign Application Priority Data
Dec. 2, 2022 (GB) 2218155.6

(51) Int. Cl. G06F 9/54; A24F 40/50; G06F 9/48; G06F 9/50

(52) U.S. Cl. CPC G06F 9/545; A24F 40/50; G06F 9/4843; G06F 9/5077

(57) ABSTRACT

There is provided an aerosol provision device, the aerosol provision device comprising a control unit for controlling an operating system in which applications are managed according to an architecture, wherein the architecture comprises a plurality of layers of logic, the layers comprising a lowermost layer for controlling hardware of the aerosol provision device, and layers above the lowermost layer which have higher levels of abstraction from the hardware, and wherein the layers of the architecture are configured to provide vertical modularity, such that the logic of each layer may be modified independently to logic of the other layers.

### TECHNICAL FIELD

The present invention relates to a modular architecture for use in an aerosol provision device, a system, an aerosol provision device comprising a control unit, and a non-transitory computer readable medium.

### BACKGROUND

Aerosol provision devices and systems are known. Aerosol provision devices and systems include computational systems that are able to provide control over the performance of the aerosol provision device/system. In this way, modern aerosol advancements have increased in complexity in an attempt to provide a better service to the user.

This has led to complex arrangements of computational architecture which can be administratively and technically difficult to construct and maintain.

The present invention is directed toward solving some of the above problems.

### SUMMARY

Aspects of the invention are defined in the accompanying claims.

According to an aspect there is provided an aerosol provision device, the aerosol provision device comprising a control unit for controlling an operating system in which applications are managed according to an architecture, wherein the architecture comprises a plurality of layers of logic, the layers comprising a lowermost layer for controlling hardware of the aerosol provision device, and layers above the lowermost layer which have higher levels of abstraction from the hardware, and wherein the layers of the architecture are configured to provide vertical modularity, such that the logic of each layer may be modified independently to logic of the other layers.

In embodiments, the layers of the architecture are configured such that the logic of each layer is only concerned with the logic of that layer.

In embodiments, successive layers above the lowermost layer have successively higher levels of abstraction from the hardware.

In embodiments, the plurality of layers comprises the lowermost layer, an uppermost layer, and one or more layers between the lowermost layer and the uppermost layer.

In embodiments, each layer is connected, for communicating data, to the one or two neighbouring layers.

In embodiments, each layer is connected, for communicating data, to the one or two neighbouring layers only.

In embodiments, the architecture is configured such that data sent from one layer to a non-neighbouring layer is passed through each intervening layer.

In embodiments, the uppermost layer is an application logic layer configured to implement the logic of an application.

In embodiments, the layers comprise an application services layer configured to implement common services, for supporting the application logic layer.

In embodiments, the layers comprise a libraries layer configured to provide tasks which are utilities for particular functionalities at the disposal of the application services layer and/or application logic layer.

In embodiments, the layers comprise a real time operating system, RTOS, layer for managing the access of tasks to hardware resources.

In embodiments, the layers comprise an application drivers layer, for defining how applications interact with functionality of hardware of the aerosol provision device.

In embodiments, the layers comprise a hardware abstraction layer, HAL, for implementing a programming interface that provides access to hardware of the aerosol provision device.

In embodiments, the HAL is configured to communicate with the one or more layers above the HAL in a manner which is not specific to the hardware of the aerosol provision device, and access the hardware of the aerosol provision device in a manner which is specific to the hardware of the aerosol provision device.

In embodiments, the layers comprise a board support package, BSP, layer, for controlling hardware of the aerosol provision device.

In embodiments, the hardware of the aerosol provision device comprises a plurality of hardware components, including:
i) hardware components which are peripherals of the control unit; and
ii) hardware components which are peripherals external to the control unit, and connected to the control unit.

In embodiments, the architecture comprises tasks, each task being in a layer of the plurality of layers, and wherein the tasks comprise logically independent tasks which are arranged in the architecture to provide horizontal modularity, such that the logic of each logically independent task in a given layer may be modified independently of the logic of other tasks in the given layer.

In embodiments, the tasks comprise at least one of: safety tasks; operational tasks; computational tasks; and, device power management tasks.

In embodiments, the tasks comprise at least one of:
a human machine interface, HMI, task arranged to control HMI interactions;
a heating task arranged to control a heating process of the aerosol provision device;
a record task arranged to control storage of usage data and system events;
a cloud task arranged to control transmission of usage data and system events;
an on-board functional safety task to control safety functions relating to vaporisation processes of the aerosol provision device;
a charger task arranged to manage charging of a battery of the aerosol provision device;
a gauge task arranged to monitor a state of charge of a battery of the aerosol provision device;
a command task arranged to control the command line interface;
a power management task arranged to control activation and termination of actions carried out by the architecture and arranged to control activation of operational and non-operational modes of the aerosol provision device;
a timer task arranged to organise on a time-basis activation and termination of actions carried out by the architecture; and
an engineering interface task arranged to manage events relating to communication hardware components according to a specific communication protocol.

In embodiments, the HMI task, heating task and timer task are within an operational task, wherein the operational task is arranged to provide activation of the aerosol provision device.

In embodiments, the charger task, gauge task and power management task are within a device power management task, wherein the device power management task is arranged to provide control over the battery condition of the aerosol provision device.

According to an aspect there is provided an aerosol provision system, comprising: the aerosol provision device of any of the above; and a consumable comprising aerosol generating material.

According to an aspect there is provided an architecture for application management within an operating system, the architecture arranged for use in an aerosol provision device, wherein the architecture comprises a plurality of layers of logic, and wherein the layers of the architecture are configured to provide vertical modularity.

In embodiments, the layers of the architecture are configured to provide vertical modularity such that the logic of each layer may be modified independently to logic of the other layers.

In embodiments, the operating system is an operating system in which applications are managed according to the architecture.

In embodiments, the layers comprising a lowermost layer for controlling hardware of the aerosol provision device, and layers above the lowermost layer which have higher levels of abstraction from the hardware.

In embodiments, the layers of the architecture are configured such that the logic of each layer is only concerned with the logic of that layer.

In embodiments, successive layers above the lowermost layer have successively higher levels of abstraction from the hardware.

In embodiments, the plurality of layers comprises the lowermost layer, an uppermost layer, and one or more layers between the lowermost layer and the uppermost layer.

In embodiments, each layer is connected, for communicating data, to the one or two neighbouring layers.

In embodiments, each layer is connected, for communicating data, to the one or two neighbouring layers only.

In embodiments, the architecture is configured such that data sent from one layer to a non-neighbouring layer is passed through each intervening layer.

In embodiments, the uppermost layer is an application logic layer configured to implement the logic of an application.

In embodiments, the layers comprise an application services layer configured to implement common services, for supporting the application logic layer.

In embodiments, the layers comprise a libraries layer configured to provide tasks which are utilities for particular functionalities at the disposal of the application services layer and/or application logic layer.

In embodiments, the layers comprise a real time operating system, RTOS, layer for managing the access of tasks to hardware resources.

In embodiments, the layers comprise an application drivers layer, for defining how applications interact with functionality of hardware of the aerosol provision device.

In embodiments, the layers comprise a hardware abstraction layer, HAL, for implementing a programming interface that provides access to hardware of the aerosol provision device.

In embodiments, the HAL is configured to communicate with the one or more layers above the HAL in a manner which is not specific to the hardware of the aerosol provision device, and access the hardware of the aerosol provision device in a manner which is specific to the hardware of the aerosol provision device.

In embodiments, the layers comprise a board support package, BSP, layer, for controlling hardware of the aerosol provision device.

In embodiments, the hardware of the aerosol provision device comprises a plurality of hardware components, including:
i) hardware components which are peripherals of the control unit; and
ii) hardware components which are peripherals external to the control unit, and connected to the control unit.

In embodiments, the architecture comprises tasks, each task being in a layer of the plurality of layers, and wherein the tasks comprise logically independent tasks which are arranged in the architecture to provide horizontal modularity, such that the logic of each logically independent task in a given layer may be modified independently of the logic of other tasks in the given layer.

In embodiments, the tasks comprise at least one of: safety tasks; operational tasks; computational tasks; and, device power management tasks.

In embodiments, the tasks comprise at least one of:
a human machine interface, HMI, task arranged to control HMI interactions;
a heating task arranged to control a heating process of the aerosol provision device;
a record task arranged to control storage of usage data and system events;
a cloud task arranged to control transmission of usage data and system events;
an on-board functional safety task to control safety functions relating to vaporisation processes of the aerosol provision device;
a charger task arranged to manage charging of a battery of the aerosol provision device;
a gauge task arranged to monitor a state of charge of a battery of the aerosol provision device;
a command task arranged to control the command line interface;
a power management task arranged to control activation and termination of actions carried out by the architecture and arranged to control activation of operational and non-operational modes of the aerosol provision device;
a timer task arranged to organise on a time-basis activation and termination of actions carried out by the architecture; and
an engineering interface task arranged to manage events relating to communication hardware components according to a specific communication protocol.

In embodiments, the HMI task, heating task and timer task are within an operational task, wherein the operational task is arranged to provide activation of the aerosol provision device.

In embodiments, the charger task, gauge task and power management task are within a device power management task, wherein the device power management task is arranged to provide control over the battery condition of the aerosol provision device.

According to an aspect there is provided a non-transitory computer readable medium comprising instructions for implementing an operating system for an aerosol provision device, the operating system comprising the architecture of any of the above.

In accordance with some embodiments described herein, there is provided a modular architecture for application management, the modular architecture arranged for use in an aerosol provision device, wherein the modular architecture comprises layers, and wherein the layers of the modular architecture are arranged to provide vertical modularity.

Such an arrangement is able to provide an improved overview of the application thereby improving the application management. Use of vertical layering more clearly demarcates the function of each specific layer than present systems. In use with a device such as an aerosol provision device this is particularly advantageous as each function may be distinct and distanced from others. Therefore, the present system is particularly advantageous for low power consumer devices such as aerosol provision devices.

The layers may be functions such as application layer, business layer or data layer. The vertical layering may relate to application layers within a microservice or a monolith.

Additional advantages related to this modular architecture relate to improved ease of maintenance and update operations as each layer provides an abstraction to the above layers. There may therefore be a high degree of independence between the layers. This allows for engineers to amend one layer without impacting other layers, to a large extent. As such, the overall user experience is improved by virtue of the ease of manufacturer handling and maintenance.

The modular architecture disclosed herein provides an agile platform which can supply a consistent performance over the lifetime of use. In this way, consumer experience of the aerosol provision device is improved. The platform may be used as a consistent platform on which methods and processes can be tested, so that a reliable performance is provided to users by virtue of a reduced likelihood of issues within the use of the functions.

The underlying services provided natively by the modular architecture are facilitators. By breaking the application feature down in modularity, the present architecture may characterise the whole implementation. This is an elegant solution to provide improved functionality and usability for small commercial devices, such as aerosol provision devices.

In an example, the modular architecture further comprises tasks, wherein the tasks of the modular architecture are arranged to provide horizontal modularity. Such an arrangement advantageously provides logical independence between tasks. In use with a device such as an aerosol provision device this is particularly advantageous as each function may be distinct and distanced from others, for example heating operations and human-machine-interface (HMI) operations. Horizontal modularity may be used to advantageously split an application into different domains, services and components. Again, separating these aspects allows for development, testing and maintenance to be done without significantly impacting other elements. This provides an architecture that is simpler to construct, implement changes to, and one that is less likely to require shut down for maintenance.

In an example, the tasks comprise at least one of: safety tasks; operational tasks; computational tasks; and, device power management tasks. Such tasks are highly important in the reliable functioning of the application operating with the architecture. As noted above, selective separation is conducive for reliability in operation and ease of maintenance and construction.

In an example, the tasks comprise at least one of: a human machine interface, HMI, task arranged to control HMI interactions; a heating task arranged to control a heating process within the aerosol provision device; a record task arranged to control storage of usage data and system events; a cloud task arranged to control transmission of usage data and system events; an on-board functional safety task to control safety functions relating to vaporisation processes of the aerosol provision device; a charger task arranged to manage charging of a battery of the aerosol provision device; a gauge task arranged to monitor a state of charge of a battery of the aerosol provision device; a command task arranged to control the command line interface; a power management task arranged to control activation and termination of actions carried out by the architecture and arranged to control activation of operational and non-operational modes of the aerosol provision device; and a timer task arranged to organise on a time-basis activation and termination of actions carried out by the architecture.

Each of these tasks are important in the provision of a suitable aerosol to a user and as such synergistically interlink with the modular architecture and the use of that architecture in an aerosol provision device.

An on-board functional safety module may manage safety functions during the vaporization process. This may include control over temperature of maximum heating timings or the like. The on-board functional safety module assists in preservation of the electronics and the safety of the user.

In an example, the HMI task, heating task and timer task are within an operational task, wherein the operational task is arranged to provide activation of the aerosol provision device. While, as mentioned above, some tasks are advantageously logically independent, certain tasks may interact together to provide a larger overall function. In particular, the HMI, heating and timer tasks may relate to the provision of an aerosol from an aerosol provision device or the like. In a use operation of such a device, the HMI, heating and timer tasks must synergistically and seamlessly interoperate to provide a suitable aerosol to the user.

In an example, the charger task, gauge task and power management task are within a device power management task, wherein the device power management task is arranged to provide control over the battery condition of the aerosol provision device, and provide an overview and understanding of the state of charge of the device. During use of an aerosol provision device, the charger, gauge and power management tasks must synergistically and seamlessly interoperate to provide to the user an understanding of the power capability of the aerosol provision device at any one time. The charger and gauge tasks indicate how much power capability the aerosol provision device has at a time, and whether that is increasing. The power management task indicates the drain on this power from the device, and can be arranged to determine the likely drain of future requests, e.g. of use. In this way, synergistically, these tasks operate to provide the user with an understanding of the power condition of the device. Accurate understanding of the power condition enables a user to reduce the likelihood of the device becoming flat and thereby increases the user experience.

In an example, at least one layer of the modular architecture is a real time operating system, RTOS, layer. Applications using the present architecture can therefore be developed in a multi task environment. While tasks may compete for use of MCU resources, facilitated by the RTOS, tasks will be cooperative from the point of view of the product features/application. As such, introduction of RTOS enables greater cooperation between tasks.

In an example, the RTOS layer is a “FreeRTOS” layer, which is an open source real-time operating system for microcontrollers. The application logic may advantageously be decomposed into tasks via a FreeRTOS layer.

In an example, the layers comprise at least one of: an application logic layer arranged to implement the product functional features by means of modular tasks; an application services layer arranged to implement common services in the form of a software development kit; a libraries layer arranged to implement application programming interfaces in the form of a software development kit at disposal of the application services layer and application logic layer; an application drivers layer arranged to implement the management of broad peripherals and microcontroller unit, MCU, peripherals based on aerosol provision device logic; a hardware abstraction layer, HAL, arranged to implement a programming interface that assists access to MCU peripherals and board peripherals through common interfaces; and, a board support package layer arranged to control board peripherals and application MCU peripherals.

Each of the layers mentioned above has an impact in the overall function of the device utilizing the architecture. It is advantageous for such layers to be arranged around any RTOS layers.

In accordance with some embodiments described herein, there is provided an aerosol provision device comprising the above described modular architecture. As mentioned above, while the architecture is advantageous in isolation, specific aspects of the architecture are synergistically advantageous when considered alongside the functionality of an aerosol provision device (provision of an aerosol, power management being used to inform a user as to what usage can be achieved etc). In embodiments, the aerosol provision device comprises a control unit for controlling an operating system, the operating system being for controlling the aerosol provision device.

In accordance with some embodiments described herein, there is provided a system comprising: an aerosol provision device; and, a consumable; wherein the aerosol provision device comprises the above described modular architecture.

In accordance with some embodiments described herein, there is provided an aerosol provision system comprising a control unit for controlling an operating system arranged according to the above described modular architecture.

In accordance with some embodiments described herein, there is provided a non-transitory computer readable medium comprising instructions for implementing an operating system for an aerosol provision device, the operating system comprising the above described modular architecture.

### DESCRIPTION OF DRAWINGS

The present teachings will now be described by way of example only with reference to the following figures:

FIG. 1 is a schematic view of a platform architecture structure according to an example;

FIG. 2 is a schematic view of a power manager according to an example;

FIG. 3 is a schematic view of an example of operation of a power manager; and,

FIG. 4 is a schematic view of an application driver according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision devices, and aerosol provision systems which comprise an aerosol provision device and a consumable comprising aerosol generating material. Aerosol provision devices and aerosol provision systems may also be referred to as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise”and “aerosolise”, may generally be used interchangeably.

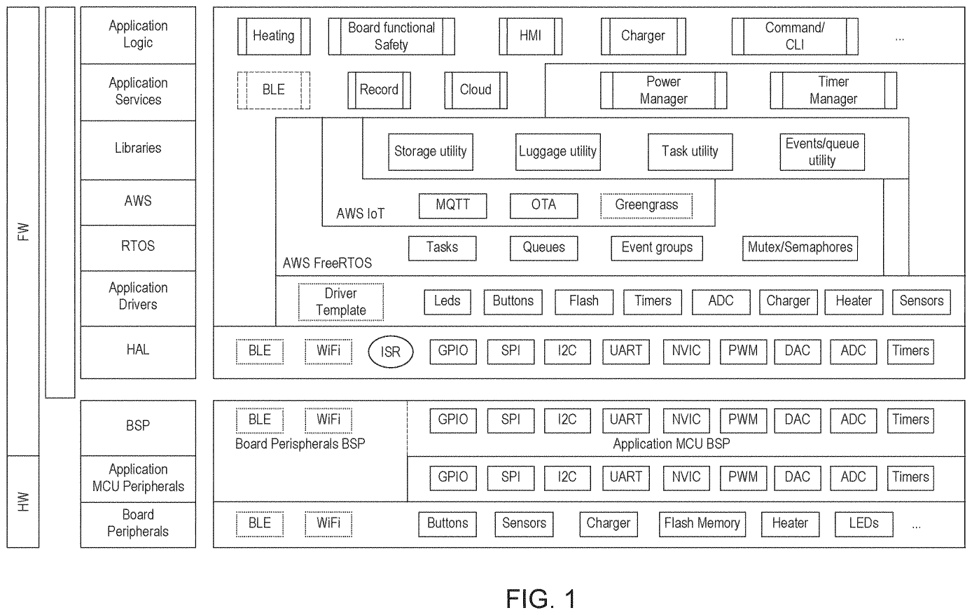

FIG. 1 illustrates a schematic view of an architecture, referred to as a platform architecture structure, according to the present invention. The platform architecture structure may be seen as a modular architecture. The modular architecture may be used in application management. For example, the modular architecture may be used by an operating system for controlling a device, in which operating system applications are managed according to the architecture. In particular, a device may comprise a control unit for controlling (e.g. running) the operating system.

The modular architecture disclosed herein is arranged for use in an aerosol provision device or similar devices. In the case of an aerosol provision device (or similar devices), the aerosol provision device may comprise a control unit for controlling an operating system, the operating system being for controlling the aerosol provision device. The operating system comprises the architecture, and applications may be managed according to the architecture.

The modular architecture shown in FIG. 1 comprises layers, which are layers of logic. These layers may also be considered to be layers of software. In this regard, the term “layer” does not necessarily place a requirement on the physical arrangement of each layer in the aerosol provision device, but rather relates to the structure of each of these separate pieces of logic, and how they are arranged with respect to one another. Each of these layers of logic can be considered as a separate piece of logic, wherein the logic of each layer may only be concerned with the logic within that layer, and not the logic of other layers.

These layers of logic are layered over the hardware of the aerosol provision device, and can be considered to be arranged in a “vertical” stack, with each layer being at a different “vertical” position above the hardware. A lowermost layer may be for controlling the hardware of the aerosol provision device, with other layers being configured to interact with the hardware by communicating with the lowermost layer. The other layers are arranged successively above this lowermost layer, and this arrangement of successive layers can be referred to as “vertical” layering.

One difficulty with the development of operating systems and applications for the operating systems can be that it is time consuming and complex to refer to the specific, physical, properties of the hardware, and the electronic signals involved in operating the hardware. As such, in an approach used by the present application, the lowermost layer may be the layer which is concerned with the specifics of the hardware. This lowermost layer can be configured to receive less specific communications relating to the hardware from the layer above, which communications may refer to the hardware in a more abstract sense. The lowermost layer can receive these less specific communications, and then action these received communications as appropriate in a specific manner relating to the hardware. With each layer being connected to (only) the neighbouring layer or layers (the connection being for communicating data from one layer to another, i.e. including sending and receiving data), this level of abstraction may increase with each successive layer, such that the logic of the upper layers, e.g. the uppermost layer, may be concerned with operating the hardware in an abstract sense which need not reference the specifics of the hardware at all.

As such, by using an architecture in which layers of logic are provided which have successively higher levels of abstraction from the (operation of the) hardware, applications may be developed in a manner which removes a requirement for these applications to be concerned with the specifics of the hardware, enabling a reduction in complexity and accordingly meaning that reliability may be improved.

Further, it may be the case that the logic of each layer can be modified independently to the logic of the other layers, for example because the logic of each layer is independent from the logic of other layers, such that the logic of each layer is only concerned with the logic of that layer. This ability to modify each layer independently may be referred to as “vertical modularity”, as each of these layers in the vertical layering may be handled by an engineer as a separate module, which may ease the development of an operating system and allow the correction of issues with the logic of each layer to be made straightforwardly. The architecture may therefore be referred to as “modular architecture”, i.e. comprising separate modules which in this case are the respective layers.

In particular approaches, each layer may be connected (for communicating data) only to the neighbouring layers (or neighbouring layer, for the uppermost and lowermost layers which have only one neighbour). As such, when an engineer places logic of an application in an upper layer, operation of the hardware which results from this application must pass through each underlying layer in order to reach the hardware. In this manner, the layers can facilitate the flow of data between non-neighbouring layers, for example from the uppermost layer to the lowermost layer and vice versa. This can also ensure that tasks (which will be discussed in further detail) in a given layer may impact the layer below in a consistent manner, rather than “jumping” one or more layers to provide a communication to a non-neighbouring layer in a manner which may change depending on programming by an engineer. This can mean that tasks may function in a more reliable and consistent manner.

Generally, the present application contemplates that the architecture comprises layers of logic including a lowermost layer, an uppermost layer, and one or more layers between the lowermost layer and the uppermost layer. Various examples of layers will now be described with reference to FIG. 1, and it is understood that each of these examples may be applied in the approach discussed above, and that various different combinations of these exemplary layers may be selected.

The layers of the modular architecture shown in the example of FIG. 1 include: application logic layer; application services layer; libraries layer; application drivers layer; and a hardware abstraction layer. Other layers shown include a board support package layer.

The application logic layer may be arranged to implement the product functional features by means of modular tasks. The application logic layer may be the uppermost layer, and may be for implementing the logic (e.g. code) of an application in the architecture. The application logic layer may also be for receiving data received by the aerosol provision device, as data received by hardware of the aerosol provision device may be communicated between the layers to arrive at the application logic layer. This uppermost layer may have the highest level of abstraction from the hardware, such that tasks in this level may refer to operation of the hardware in the most general sense.

The application services layer may be arranged to implement common services, for example in the form of a software development kit. This layer may be below the application logic layer, neighbouring the application logic layer, and connected to the application logic layer. Further, this layer may be for supporting the application logic layer, for example to provide checks on the implementation of instructions received from the application logic layer. For example, if a task in the application services layer includes an instruction for a heating process to begin, the application services layer may check whether certain criteria for the heating process to begin are met, such as checking that there is a sufficient amount of remaining charge in a battery of the aerosol provision device.

The libraries layer may provide tasks which are utilities for particular functionalities at the disposal of the application services layer and the application logic layer. The libraries layer may be below the application services layer, and connected to the application services layer, and in some arrangements is connected to the application logic layer. For example, a task in the application services layer may include an instruction for a particular functionality to take place, and the libraries layer may include a task which is a utility for this functionality. These tasks may be developed in a standard manner, such that they are standardised and may be repurposed across various different applications which may be for the operating system.

The application drivers layer may be arranged to implement the management of hardware of the aerosol provision device. The hardware includes the control unit for controlling the operating system for controlling the aerosol provision device, and in this example the control unit is a microcontroller unit, MCU, comprising a microprocessor and a plurality of peripherals of the MCU. The hardware also includes a board which this control unit is implemented on, and a plurality of peripherals, referred to as board peripherals, connected to the control unit, and external to the control unit. The application drivers layer may be arranged to implement the management of hardware including the broad peripherals and MCU peripherals, based on aerosol provision device logic. This layer may define how applications interact with the functionality of the hardware. This layer may be below the libraries layer, and connected to the libraries layer. As such, a task in the libraries layer which is caused by a particular application may cause a task in the application drivers layer which involves an interaction with the hardware of the aerosol provision device in a manner defined by the application drivers layer.

The hardware abstraction layer, HAL, may be arranged to implement a programming interface that assists access to hardware of the aerosol provision device, including MCU peripherals and board peripherals, for example through common interfaces. This layer may be below the application drivers layer, and connected to the application drivers layer. This layer may interact with the hardware of the aerosol provision device on a low level, such that tasks in this layer, for example which result from an interaction of an application in the application drivers layer, may apply a low level instruction to hardware. The HAL (and the tasks of the HAL) may be configured to communicate with the levels above in a (standardised) manner which is not specific to the hardware of the aerosol provision device. In other words, regardless of the specific hardware components (e.g. the specific hardware component used for each type of hardware component) implemented in the hardware of the aerosol provision device, the HAL may still be configured to communicate with the layers above in the same manner. By contrast, the HAL (and the tasks of the HAL) may be configured to access the hardware (and communicate with one or more layers below the HAL) in a manner which is specific to the hardware of the aerosol provision device.

The board support package, BSP, layer may be arranged to control hardware of the aerosol provision device, including board peripherals and application MCU peripherals. Specifically, the BSP layer may be configured to control the physical properties of the hardware of the aerosol provision device (e.g. the hardware components of the hardware of the aerosol provision device). This layer may be below the HAL, and connected to the HAL. This layer may generally be provided by the manufacturer of each hardware component with the hardware component, and may relate to defining the format of specific physical and electrical signals are required to interact with the hardware to cause particular results. As such, this layer may be specific to the hardware of the aerosol provision device. This layer may be the lowermost layer.

The layers may be configured to implement application programming interfaces, APIs, which define how communications between layers takes place, using the connections between the layers. The APIs may define a communications scheme for how data is communicated between layers, which stipulates, for example, the format of data being communicated between layers.

Together, a plurality of layers such as these may be considered to provide a software development kit, SDK, in that they may (each) include one or more tasks that provide functionality for an application implemented in the architecture to utilise. An architecture including a plurality of layers in this manner, with tasks which may be predefined, in the sense that they are “built in” to the architecture, can therefore enable the implementation of different applications on different hardware that nonetheless uses these layers and tasks in a similar manner, meaning that the layers and tasks need not be developed from scratch for each new application and new hardware.

Broadly shown in the example of FIG. 1 are the relevant and respective firmware (FW) and hardware (HW) portions. The hardware of the aerosol provision device comprises the MCU, as discussed above, which may be running the operating system and application logic, including the peripherals of the MCU, as well as the board peripherals external to the MCU which are present on the product board, for example along with the MCU.

The hardware of the aerosol provision device comprises the MCU and the peripherals of the MCU, which as depicted in FIG. 1 includes a plurality of hardware components. These hardware components will now be listed. A general-purpose input/output, GPIO, hardware component for receiving inputs to the MCU and providing outputs from the MCU. A serial peripheral interface, SPI, hardware component is for synchronous serial communication with the MCU. An inter-integrated circuit, I2C, hardware component is a serial communication bus for connecting peripherals to the MCU. A universal asynchronous receiver-transmitter, UART, hardware component is for communicating with external devices. A nested vectored interrupt controller, NVIC, hardware component is for providing a response of the MCU to interrupt events. A pulse width modulation, PWM, hardware component is for controlling the generating of variable width pulses. A digital-to-analogue convertor, DAC, hardware component is for transforming information from a digital form to an analogue form. An analogue-to-digital converter, ADC, hardware component is for transforming information from an analogue form to a digital form. A timer hardware component is for organising on a time-basis activation and termination of actions.

As depicted in FIG. 1, for each of these hardware components which are peripherals of the MCU there is a corresponding task in the BSP layer for controlling the hardware component. Further, there is a corresponding task in the HAL for accessing the hardware component. The task in the BSP layer for controlling the hardware component is specific to the hardware component, and in many instances is developed by the manufacturer of the hardware component. As such, if a particular hardware component is changed, then the respective task in the BSP layer is also changed. Further, as the corresponding task in the HAL is also configured to interact with the task in the BSP, as well as tasks in the layers above, the task in the HAL would also need to change if the task in the BSP changes. However, the changed task in the HAL would still be configured to interact with the tasks in the layers above in the same manner as before, meaning that a change in the hardware does not need to impact tasks in layers above the HAL. Accordingly, these tasks in layers above the HAL can be applied across various devices and hardware.

The hardware of the aerosol provision device also comprises, for example on a product board along with the MCU, board peripherals which are external to the MCU. These board peripherals include communication hardware components of the aerosol provision device for communicating with external devices, such as any wired or wireless communication hardware components including the BLE hardware and WiFi hardware components of the hardware (HW) portion depicted in FIG. 1, which are controlled by respective tasks of the BSP layer, such as a BLE task and WiFi task in the BSP layer respectively. This communication hardware components, such as the BLE hardware component and the WiFi hardware component, can be accessed by respective tasks of the HAL, such as a BLE task and WiFi task. Further, the board peripherals include buttons, sensors, a charger, flash memory, a heater, and LEDs, all of which may be at least partly on the product board.

As discussed above, the layers of logic of the modular architecture can provide vertical modularity, and can provide advantageous separation between e.g. the logic and libraries portions of the architecture. This abstraction to the layers above occurs via well-defined interfaces between neighbouring layers. This arrangement in which each layer is separate allows each layer to be updated and maintained with a high degree of independence from other layers. The vertical layering also provides a better overview of the application within which the modular architecture operates. The layers disclosed herein clearly demarcate the functions of one portion of the architecture from another. Each of these traits combine to assist avoiding direct access between many layers, e.g. in the case that each layer is connected only to the neighbouring layers, which has been found to complicate manufacture and maintenance of such architectures.

FIG. 1 shows a series of layers. Within the layers shown are an optional web service for communicating with a remote system such as a server on the cloud, for example using standard protocols, which in this case is an Amazon Web Services, AWS, although other options are available. This web service, when present, may be comprised in a real time operating system layer, RTOS. The RTOS layer may be leveraged as one of the abstraction layers of the modular architecture. In particular, the RTOS layer may manage the access of tasks to processing resources of the hardware, e.g. in real time. In combination with this, the application services layer can hide the details of calls to an underlying RTOS layer. This further decouples an application in the application logic layer from this RTOS layer, and allows for the creation of new, useful and reusable services over time.

A broad advantage of the architecture shown is that an application, for example implemented in the application logic layer and any other layers, can be compartmentalised. The application may be divided into simpler components, e.g. within each layer, that are logically independent from one another, and logically independent from other such components within the same layer. These components can be constructed separately and maintained separately. This provides the opportunity for each to be focussed on a specific functional objective.

This compartmentalisation of the components of applications within particular layers may be considered an aspect of vertical layering. These may be components of an application within a microservice or a monolith. The modularity disclosed herein on the whole improves the testing of these components separately in turn, and the creation of these components. In turn this increases ease of construction and development of the application alongside providing extension units for the application. The overall creation of the application is vastly improved.

In an example, the modular architecture further comprises tasks. In an example, the tasks of the modular architecture are arranged to provide horizontal modularity. Horizontal “layering” may be used herein to refer to horizontal modularity, wherein tasks which are arranged to provide horizontal modularity may be modified independently of the logic of other tasks in the given layer, for example because these tasks are logically independent tasks. This term may refer to the splitting of the application into different components (and/or domains and/or services), for example within a particular layer. Each split allows greater focus to be provided to that specific aspect and therefore a more directed result to be achieved, e.g. excellent heater control provided to an aerosol provision device requiring of precise heater control to provide a desirable aerosol to a user. The term “tasks” may be used herein to refer to “application logic tasks”specifically.

In the example of FIG. 1, tasks shown may be safety tasks, operational tasks, computational tasks and/or device power management tasks. Such thematic subsystems could advantageously be used in a simple mechanical device such as an aerosol provision device wherein certain operations may be separated from one another without impacting user experience of the device. As such, the particular arrangement shown herein is particularly advantageous for aerosol provision devices and the like.

Specifically shown tasks in the architecture of FIG. 1 include: a human machine interface, HMI, task arranged to control HMI interactions; a heating task arranged to control a heating process within the aerosol provision device; a record task arranged to control storage of usage data and system events; a cloud task arranged to control transmission of usage data and system events; an on-board functional safety task to control safety functions relating to vaporisation processes of the aerosol provision device; a charger task arranged to manage charging of a battery of the aerosol provision device; a gauge task arranged to monitor a state of charge of a battery of the aerosol provision device; a command/CLI task arranged to control the command line interface; a power management task arranged to control activation and termination of actions carried out by the architecture and arranged to control activation of operational and non-operational modes of the aerosol provision device; and a timer task arranged to organise on a time-basis activation and termination of actions carried out by the architecture. The timer task, in the control of an aerosol provision device, may relate to the use of a non-functioning, conserving mode such as a sleep function.

The power management task and timer task are shown as part of the application services layer. The remaining tasks mentioned above are shown as part of the application logic layer. The application logic layer represents the upmost level of the platform, where the application logic of the product can be implemented. This top layer represents the highest level of abstraction based on the underlying layers, making use of the application services layer and libraries layer. The tasks noted above, and shown as present in the application logic layer of FIG. 1, is not exhaustive.

The charger and gauge tasks may be integrated for the purposes of low charge devices, such as aerosol provision devices or the like. The HMI may be operated by a user using LEDs or buttons or the like. This may improve the use of the HMI on a device such as an aerosol provision device.

Other tasks shown include the record task which may store usage information, systems events etc into an external memory or the like. Other tasks shown include a BlueTooth Low Energy, BLE, task. This may provide some communicational function to the aerosol provision device.

mentioned above, the power management task and timer task are shown as part of the application services layer. A role of the application services layer is to provide common services in the form of an SDK. The application services may involve broadcast of temporal events or application dependent events to all the tasks that subscribe for such, and the uniform and centralized management of power management for the product in which the architecture is operating.

The coarse software timing may be managed by the timer manager. The time manager generates events, accessible by all tasks that subscribe. Such events may be generated every 100 ms, every second or every ten seconds. Operations that are performed repetitively, iteratively or cyclically may rely on such events for timing, provided timing precision is acceptable. Such acceptability depends on the task operation.

The power manager service supervises the activities carried out by the application logic and when these activities are terminated. The power manager service allows the product (i.e. the aerosol provision device) to enter in low power consumption modes, by notifying the relevant event to the application logic that can, for example, switch off the directly controlled HW peripherals. The power manager service also controls the awakening of the product when the proper conditions occur, notifying the relevant event to the application tasks.

An aerosol provision device may have two operational states: sleep mode and awake mode. In sleep, the device is put into low power consumption mode. The CPU is halted in low power and all other peripherals are stopped. The CPU can be awakened by interrupts generated by the peripheral. In awake mode the CPU is configured to operate at the maximum frequency, and peripherals can operate according to their application logic requirements.

The power manager is the task that decides if the product or device has to enter sleep mode to reduce the power consumption to save battery. This may occur in low battery conditions.

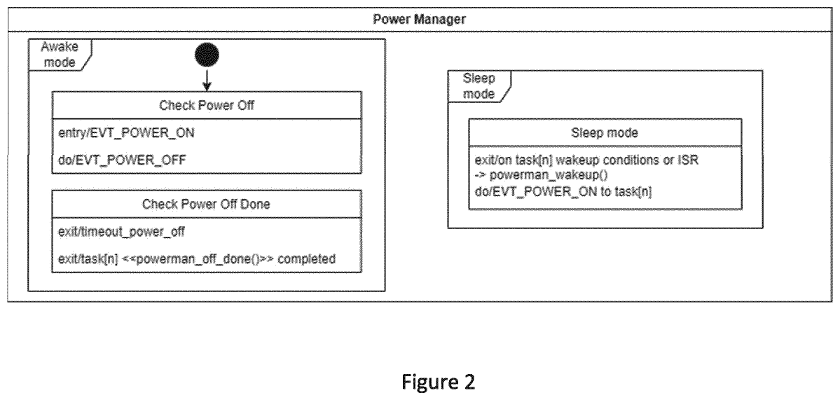

FIG. 2 is a schematic view of a power manager according to an example. The power manager of FIG. 2 has awake mode and sleep mode shown. To enter the sleep mode, all the application logic tasks shall have terminated their activities. FIG. 2 is a statechart diagram showing the behaviour of the power manager.

When Application logic tasks have terminated the activities the power manager can issue the event EVT_POWER_OFF for all the interested tasks. After issuing the event EVT_POWER_OFF the power manager may wait for a given number of seconds (timeout_power_off TBD) before entering in sleep mode, giving the tasks a dynamic timeout to switch off, in a safe condition, the devices they manage. Tasks that have to perform some operation with their controlled device before entering in sleep mode at the end of their operation and before the timeout_power_off is elapsed, signal the end of the operations to the power manager task with the API powerman_off_done( ).

When the tasks have suitably finished and signalled with powerman_off_done( ) even if the timeout timeout_power_off is not elapsed, the power manager task will put the device in sleep mode. If the timeout timeout_power_off elapses before all the tasks have finished their low power activities, the power manager task will put the device in sleep mode tracing the condition. In summary, the device will enter in sleep mode when all the tasks, enabled for power management logics, have completed their operation declaring the end with the API powerman_off_done( ) or when then timeout_power_off is elapsed.

Using the task utility libraries, shown in FIG. 1, a task may be configured to adhere to the power management rules.

The power manager has a responsibility to communicate the wakeup of the product to all the interested tasks: such notification is done issuing the event EVT_POWER_ON. The notification can be issued for example when a button is pressed.

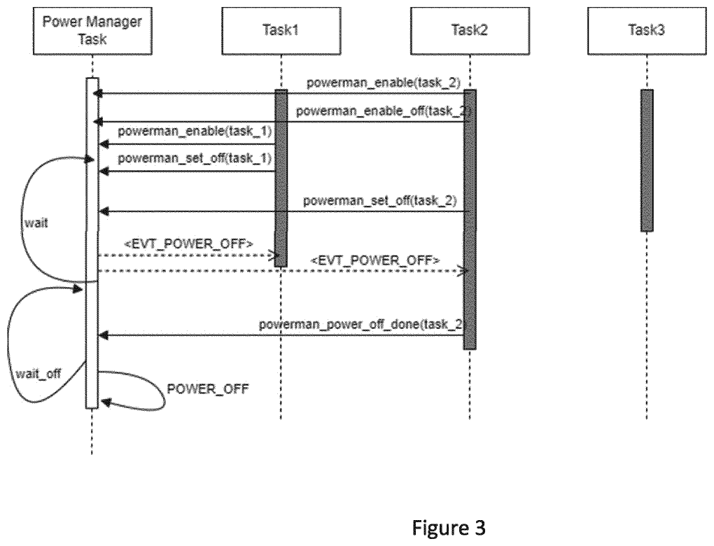

FIG. 3 is a schematic view of an example of operation of a power manager. Specifically, FIG. 3 illustrates an intended theory of operation between three tasks (task1, task2, task 3) and the power manager task. A task that needs to interact with the power manager will be able to create the task a priori, or use APIs shaped as shown in FIG. 3.

The messages shown in FIG. 3, can broadly be considered as follows:
powerman_enable (task_ID): enable a specified task to decide to keep the product (e.g. aerosol provision device) awake
powerman_enable_off (task_ID): enable a specified task to perform operation hardware to switch off devices controlled in a safer mode after having received the EVT POWER OFF event
powerman set_off(task_ID): an enabled task gives its consent to turn off the product
powerman_set_on(task_ID): an enabled task requests that the product remain on
powerman_off_done(task ID): an enabled task informs the power manager that after having received the EVT_POWER_OFF event it has turned off the hardware device it controls and therefore the product can safely proceed to shutdown

In the example of FIG. 3, task1 and task2 are enabled to handle low power consumption. Task3 is not involved in low power consumption management. Task2 is also enabled to receive notification of the imminent entry into low power consumption to allow it to switch off devices that have a certain time sequence or need a specific switch-off sequence in a safe way.

Tasks that consent to turn off the product notify this to the power manager via “powerman_set_off” messages. The power manager will then have a “wait” loop that waits to collect all such “set_off” messages before powering off the product, in which case it notifies the tasks with the EVT_POWER_OFF event message.

A task, such as task2, may need to ensure that certain safety or consistency controls are done before power off, in which case it will notify this to the Power Manager via a powerman_enable_off message. In such case, the Power Manager, after sending the EVT_POWER_OFF event message, shall wait (“wait_off” loop in the figure) for a powerman_off_done message from such task before proceeding to power off.

Referring back now to FIG. 1, within the libraries layer, there are shown tasks including storage utility, logging utility, task utility and events/queue utility. The libraries layer may be a software interface that sits between the RTOS layer and the application logic layer, and which will be used by the application services layer. The utilities of the libraries layer may be provided to other layers by APIs and macros. The cloud task shown may arrange sending usage information and system events present in external memory or the like to a server through WiFi or BLE.

Task utility may involve centralized creation of tasks with events service, queue service, and power manager service in a single API. In an example, a task may be able to also expose a subset of services by means of dedicated APIs. Task utility may improve the configuration and creation of tasks within the project, defining the characteristics of the task in a single place. This improves the ease with which tasks may be configured and created.

Within the architecture, it is possible to specify whether a task must interact with the power manager in order to keep the product on and give consent to power off (pwrman_enable, from FIG. 3). A controller of the architecture may specify whether a task must interact with the power manager to give final consent to power off, after the power manager has notified that the product must shut down. This may apply to tasks that manage peripherals that cannot be turned off instantly but need a procedure of turning off (pwrman_off).

Other functionality offered by the present system include the possibility of specifying whether a queue is to be used for a task and how many elements such a queue must be constructed from to receive data.

Task utility may have a series of commands that can be used to create a list of tasks. A configuration file may be formed to hold a list of the tasks using a macro, TASK_UTILITY_CREATE. The following details may be used in such a list:
task_ID: reference to the task created returned by the API
task_name: logical name of the task in string format
task_function: entry point function task
task_param: pointer to optional parameters to pass to the task if needed (NULL otherwise)
task_priority: priority to assign to the task
task_stack_size: size of the RAM area reserved for the stack of the task
queue_size: maximum number of messages that can be stored in the receive FIFO queue of the task itself (the payload of the message (sent by copy) will be placed in the heap). Set to 0 if the task does not need a queue.
pwrman_enable: can be [0, 1] and serves to recruit or not the task for the power management decision. If set to 0, the task cannot take part in any decisions that affect the power management. If set to 1 the task can keep awake the product till the end of its operations. (the power manager task, when no other task is keeping the product awake, will send to all tasks the event EVT_POWER_OFF in order to signal all tasks to configure themselves and their peripherals to enter in sleep mode)
pwrman_off: can be [0, 1] and is used to enable or disable the task management of the delayed shutdown. When the power manager task determines that the conditions exist for entering in low-power, it generates the event EVT POWER OFF and then waits for the slower tasks for which the off time is not predictable a priori until they have turned off the devices controlled by them. For these tasks it is therefore possible to enable the management of the delayed shutdown.
events_enable: can be [0, 1] and serves to enable or not the task for the global events management. If the task will be involved in power management activity (pwrman_enable=1 or pwrman_off=1) or if queue service is needed, this value will be overwritten to 1.

Referring to FIG. 1, there is shown an events/queue utility in the libraries layer. Events/queue utility provides a centralized manager to dispatch events or send messages for application tasks. This utility may arrange operation performance within the overall arrangement of performances. For example, the events utility may ensure that a detection task is performed to ensure a device, e.g. an aerosol provision device, is suitable to operate. The queue utility may ensure that aspects of performance that need to occur sequentially occur in such a sequence. In an example, an aerosol provision device has a valve to release aerosol from the device and a heater to generate an aerosol. The order should be generate aerosol then open valve. The queue utility may be used to provide control over such performance, thereby leading to improved user experience of the device. In this way, the events/queue utility may operate as a centralized receiver (blocking or non-blocking) for receiving subscribed events/messages by the application tasks. The receiver may be provided as a single entry point for both receiving events and messages from queues, simplifying the usage by the application tasks.

The events utility therefore allows management of a number of events for each task. For a 32 bit mask, the events utility can manage up to 32 events. In an example, less significant events can be handled by being freely assigned to individual tasks for local usage (e.g. to receive events from a low-level driver thus affecting only the task that manages the device that generates that event). In a specific example, the least significant 16 events may be so freely assigned.

Local task events and global task events may differ by local tasks being e.g. task events that are specific and local to specific application tasks. This may include defining events that a task needs to receive from other tasks or from other application device drivers.

The queues utility will allow the exchange of data between different tasks with the benefit of being able to transfer information by copy. Advantageously, the sender of the information need not keep the information intact after having sent the information.

When a task writes data to the tail of another task, the latter will receive an event of type EVT_QUEUE_MSG_RX. In this way, each task can start listening for events, while remaining dormant otherwise, in this way the consumption of CPU resources is advantageously limited. Upon reception of one or more events, the task will be awakened by the operating system according to its priorities and it can manage events. If one of them is the EVT_QUEUE_MSG_RX, data can be retrieved from the queue created by the library.

Using this technique and approach, there is an arrangement wherein tasks can wait indefinitely for events or data, while doing so in a low power consumption mode. This advantageously improves the user experience of the device on which the application is run, as the power consumption is minimised. Furthermore, less power is required to run the application and as such this is more energy efficient that previously disclosed architectures.

Another example of a task is an Engineering Interface, EI, task (not depicted in FIG. 1), which is arranged to manage input events and output events according to a specific communication protocol. These input events and output events relate to communication hardware components of the aerosol provision device for communicating with external devices, which may be wired communication hardware components or wireless communication hardware components such as the BLE and WiFi hardware components of the hardware (HW) portion depicted in FIG. 1, which are controlled by respective tasks of the BSP layer, such as a BLE task and WiFi task in the BSP layer respectively. These communication hardware components, such as the BLE hardware component and the WiFi hardware component, can be accessed by respective tasks of the HAL, such as a BLE task and WiFi task.

The EI task may be in the application services layer, and is arranged to manage input events and output events which relate to these tasks of the HAL. The EI task waits for an input or output event to arrive (e.g. from a communication hardware component, received from a task in the HAL), and when such an event arrives, it is arranged to check that the arrived event is correctly formatted, according to a specific communication protocol. This specific communication protocol may be a specific communication protocol associated with an authorised engineer, such that events which accord with the specific communication protocol are considered to be associated with an authorised engineer. If the event is correctly formatted, the EI then determines the relevant action to take, based on the type of event which has arrived. Depending on the determined relevant action to take by the EI, the EI then instructs the relevant task, in the application logic layer (and/or application services layer) accordingly.

The EI task may be used for managing input events and output events relating to control of the aerosol provision device by an authorised engineer, for example in the context of testing particular functionality of the aerosol provision device. For example, in the case of an input being received by a communication hardware component (e.g. the BLE hardware component), the BLE task in the HAL may provide a corresponding input event to the EI task. The EI task can then check that the input event is correctly formatted (according to the specific communication protocol), and determine the relevant action to take, based on the type of input event which has arrived, and instruct a task in the application logic layer accordingly. In the case that the input event relates to the receipt of an input by the communication hardware which is an instruction to begin heating, the EI task may accordingly instruct the heating task in the application logic layer.

By using this EI task which manages input events and output events from various (different) communication hardware components according to the same specific communication protocol, the protocol by which the same type of event received from different communication hardware components is managed may be standardised. As such, tasks which receive instructions form the EI need not be concerned with the different approaches used by different communication hardware components, and accordingly the creation and testing of these tasks may be more straightforward, and their operation may be more reliable.

The example of FIG. 1 has a logging utility. The logging utility may be a lightweight logging library utility (which may be configured at compile time). The utility may work dynamically on the universal asynchronous receiver-transmitter, UART, communication line when the command-line interface, CLI, is disabled (or, for example, on dedicated debug channels).

The logging library may allow logging activity on the serial line used by the CLI, when the CLI is not active. The logging may be configurable at compile time for each module/task that needs to log information for, e.g., debugging/testing activities. The logging library may comprise a set of macros, so that if the log to be issued has a level lower than the default logging level selected for the module, it will be excluded by the compiler.

The storage utility shown in FIG. 1, may be a library to store, retrieve and erase data on external flash memory, abstracting the flash memory as a circular buffer (through flash sectors).

The storage library may act to abstract how application records are stored/read to/from an external memory, e.g. an external flash memory. The information content of data records saved by the library may be transparent to the library itself. Records read and sent to the cloud could be marked as read, in order not to be sent twice. Such an arrangement therefore removes unnecessary duplication of effort, thereby rendering the proposed architecture more efficient. The library will manage the memory as a circular buffer releasing memory sectors when all data contained in a sector is fully uploaded to the cloud.

The arrangement of FIG. 1 may also have a driver utility. This may provide centralized drivers initialization, entering/exiting from low power for all the drivers provided in a specific configuration file (e.g. driver_conf.h).

FIG. 1 also shows, as an example option, the AWS web service comprising an AWS Internet of Things, IoT, and the RTOS layer comprising an RTOS which is an AWS FreeRTOS (although other types of RTOS may be used). These are two services that may provide use in such an architecture. AWS IoT provides further optional functionality built on top of an RTOS, that allows connected devices to communicate with AWS cloud applications, while AWS FreeRTOS is an open source real-time operating system for microcontrollers distributed free of charge under licence. Such arrangements may be used in the architecture proposed.

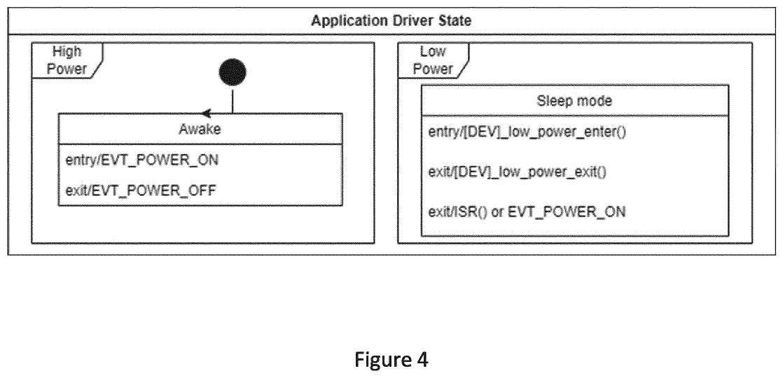

FIG. 1 shows an application drivers layer. FIG. 4 shows a schematic statechart diagram of a behaviour of an application driver status against power management events. In the present architecture, the application drivers (or “platform drivers”) layer may standardise and implement the same, or a similar, public interface. In this way, common functionality is provided across the drivers. Each driver may implement functions to initialize, configure, entering/exiting to/from low power mode, open, close, write, read, or handle periodic activities with the hardware peripheral. For convenience of discussion, in the following paragraphs the term “device”may refer to a hardware peripheral.

Generic drivers implement functions to control devices. These functions may include: initializing the device; initializing the device to start in low power (such a function may be called the first time and/or every time the sleep mode is issued); and, initializing the device to start in high power (such a function may be called the first time and/or every time the run mode is issued).

FIG. 4 shows the envisaged behaviour of an application driver, in awake, high power mode or sleep, low power mode. In general, drivers may be structured to operate upon events and then the use of interrupts assist in managing the underlying hardware.

If a peripheral driver must be used by more than one task, it must be designed to operate on data in an atomic and protected way by means of software patterns, such as mutexes or critical regions in interrupt service routines, which allow to avoid conflicts in concurrent access to resources.

The engine of each driver may be guided by the respective interrupt handlers for the device that the driver manages and will interface with the operating system only to generate events to the task that uses that device/driver. In an example this may be to indicate the presence of data or the end of a command operation. The drivers may filter out, as much as reasonably possible, the information received from the devices to provide to the tasks information which is “valid” and “clean”.

By combining the advantages of both decomposition of applications into independent tasks and the generic services abstraction, the operational benefit of allowing different developers to work independently and concurrently on the same project may be provided, further increasing ease of production and maintenance of the application.

The architecture disclosed herein may be part of an operating system for controlling a device, such as an aerosol provision device. A control unit of the aerosol provision device may control an operating system according to, within the framework of, or comprising the architecture disclosed herein. The architecture may be held on computer readable media, which may be transient or non-transient.

A computing system, which in this case is the control unit, runs the operating system, or may be seen to use or execute the operating system. The operating system may comprise or use the modular architecture disclosed herein. This architecture may be present in a device such as an aerosol provision device by storage in memory. Alternatively, the architecture may be delivered via signal waves or on a carrier wave or the like.

The above disclosed architecture provides a number of advantages over previous systems. The architecture herein creates independent layers of abstraction. This increases the ease of construction, testing and maintenance of specific functions from the architecture operating within a device such as an aerosol provision device. Use of the RTOS layers, such as a FreeRTOS layer, provides a decomposition of the application logic into specific tasks. This improves resilience of the operation of the aerosol provision device controlled by the architecture. The architecture provides for an SDK of services and libraries for the application. The architecture provides for templated application drivers. The architecture provides a HAL of normalized programming interfaces. The architecture herein also provides configurability of the codebase for different targets.

The architecture provides great flexibility in construction and maintenance and is particularly well suited for smaller commercial devices operating on low power with a variety of functions that benefit from logical abstraction.

Furthermore, the segregation of functions is particularly advantageous for use in an aerosol provision device. As an example of operations within an aerosol provision device, heating of the aerosol is very segregated in function from control of the display screen. As such, the aerosol provision device can be seen as siloed in operation, therefore the modular arrangement of the architecture is particularly effective for a low power aerosol provision device. The controls for the heating can be built and tested separately to the controls for the HMI and this leads to easier construction, maintenance and updating of the individual functions operating within the aerosol provision device.

As such, there is disclosed herein a reliable and robust architecture for controlling the operations within an aerosol provision device.

In a particular example, the device disclosed herein may operate with a flavour pod which is replaceable in the device—this may be referred to as a consumable. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating material, for example a consumable comprising aerosol generating material, the aerosol provision device as disclosed herein may be referred to as an aerosol provision system.

Thus there has been described an aerosol provision device, for providing an aerosol for inhalation by a user, comprising: a control unit for controlling an activation state of the aerosol provision device; a detector arranged to detect an air output associated with a user of the aerosol provision device; wherein the control unit is arranged to update an activation state of the aerosol provision device in response to receiving a signal from the detector associated with an authorised user.

The techniques discussed herein may be used in a product. The product may (or may not) be a tobacco industry product. For example, the product may be a non-combustible aerosol provision system.

In one embodiment, the product comprises one or more components of a non-combustible aerosol provision system, such as a heater and an aerosolizable substrate, also referred to as an aerosol generating material.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision device, the aerosol provision device comprising a control unit for controlling an operating system in which applications are managed according to an architecture,
wherein the architecture comprises a plurality of layers of logic, the layers comprising a lowermost layer for controlling hardware of the aerosol provision device, and layers above the lowermost layer which have higher levels of abstraction from the hardware, and
wherein the layers of the architecture are configured to provide vertical modularity, such that the logic of each layer may be modified independently to logic of the other layers.

2. The aerosol provision device of claim 1, wherein the layers of the architecture are configured such that the logic of each layer is only concerned with the logic of that layer.

3. The aerosol provision device of claim 1, wherein successive layers above the lowermost layer have successively higher levels of abstraction from the hardware.

4. The aerosol provision device of claim 1, wherein the plurality of layers comprises the lowermost layer, an uppermost layer, and one or more layers between the lowermost layer and the uppermost layer.

5. The aerosol provision device of claim 1, wherein each layer is connected, for communicating data, to the one or two neighbouring layers.

6. The aerosol provision device of claim 5, wherein each layer is connected, for communicating data, to the one or two neighbouring layers only.

7. The aerosol provision device of claim 1, wherein the architecture is configured such that data sent from one layer to a non-neighbouring layer is passed through each intervening layer.

8. The aerosol provision device of claim 1, wherein the uppermost layer is an application logic layer configured to implement the logic of an application.

9. The aerosol provision device of claim 8, wherein the layers comprise an application services layer configured to implement common services, for supporting the application logic layer.

10. The aerosol provision device of claim 9, wherein the layers comprise a libraries layer configured to provide tasks which are utilities for particular functionalities at the disposal of the application services layer and/or application logic layer.

11. The aerosol provision device of claim 1, wherein the layers comprise a real time operating system, RTOS, layer for managing the access of tasks to hardware resources.

12. The aerosol provision device of claim 1, wherein the layers comprise an application drivers layer, for defining how applications interact with functionality of hardware of the aerosol provision device.

13. The aerosol provision device of claim 1, wherein the layers comprise a hardware abstraction layer, HAL, for implementing a programming interface that provides access to hardware of the aerosol provision device.

14. The aerosol provision device of claim 13, wherein the HAL is configured to communicate with the one or more layers above the HAL in a manner which is not specific to the hardware of the aerosol provision device, and access the hardware of the aerosol provision device in a manner which is specific to the hardware of the aerosol provision device.

15. The aerosol provision device of claim 1, wherein the layers comprise a board support package, BSP, layer, for controlling hardware of the aerosol provision device.

16. The aerosol provision device of claim 1, wherein the hardware of the aerosol provision device comprises a plurality of hardware components, including:
i) hardware components which are peripherals of the control unit; and
ii) hardware components which are peripherals external to the control unit, and connected to the control unit.

17. The aerosol provision device of claim 1, wherein the architecture comprises tasks, each task being in a layer of the plurality of layers, and
wherein the tasks comprise logically independent tasks which are arranged in the architecture to provide horizontal modularity, such that the logic of each logically independent task in a given layer may be modified independently of the logic of other tasks in the given layer.

18-22. (canceled)

23. An architecture for application management within an operating system, the architecture arranged for use in an aerosol provision device,
wherein the architecture comprises a plurality of layers of logic, and
wherein the layers of the architecture are configured to provide vertical modularity.

24. The architecture of claim 23, wherein the layers of the architecture are configured to provide vertical modularity such that the logic of each layer may be modified independently to logic of the other layers.

25. A non-transitory computer readable medium comprising instructions for implementing an operating system for an aerosol provision device, the operating system comprising the architecture of claim 23.
